(19) United States
(12) Patent Application Publication
(10) Pub. No.: US 2026/0338082 A1
(43) Pub. Date: Oct. 29, 2026

(54) VARIABLE VANE OF AN AIRCRAFT TURBINE ENGINE STATOR, AND AIRCRAFT TURBINE ENGINE

(71) Applicant: SAFRAN AERO BOOSTERS, Herstal (BE)

(72) Inventor: Rémy Henri Pierre PRINCIVALLE, Herstal (BE)

(21) Appl. No.: 19/101,680

(22) PCT Filed: Jul. 24, 2023
(86) PCT No.: PCT/EP2023/070416

§ 371 Date: Feb. 6, 2025

(30) Foreign Application Priority Data
Aug. 9, 2022 (BE) BE2022/5620

(51) Int. Cl. F01D 17/16; F01D 9/04

(52) U.S. Cl. CPC F01D 17/162; F01D 9/041; F05D 2240/80

(57) ABSTRACT

A variable-pitch turbine engine stator vane. The blade including a blade for guiding an air flow; and one or two platforms arranged at one end or at both ends of the blade. The platforms including a surface for guiding the air flow. The surface including a first disc portion on the intrados side and a second disc portion on the extrados side. At least one of the first or second disc portions includes a bump.

### TECHNICAL FIELD

The invention relates to turbomachine stator blades and more particularly to the design of variable-pitch blades with surface contouring.

### PRIOR ART

Climate change is a major concern for many legislative and regulatory bodies around the world. Indeed, various restrictions on carbon emissions have been, are being or will be adopted by various states. In particular, an ambitious standard applies both to new types of aircraft but also to those in circulation requiring the implementation of technological solutions in order to make them compliant with current regulations. Civil aviation has been mobilizing for several years now to make a contribution to the fight against climate change.

Technological research efforts have already made it possible to significantly improve the environmental performance of aircraft. The Applicant takes into consideration the impact factors in all phases of design and development to obtain less energy-intensive, more environmentally friendly aeronautical components and products whose integration and use in civil aviation have moderate environmental consequences with the aim of improving the energy efficiency of aircraft.

Consequently, the Applicant is constantly working to reduce its negative climate impact by using methods and operating virtuous development and manufacturing processes and minimizing greenhouse gas emissions to the minimum possible in order to reduce the environmental footprint of its activity.

This sustained research and development work covers new generations of aircraft engines, the weight reduction of aircraft, particularly through the materials used and the lighter on-board equipment, the development of the use of electrical technologies to provide propulsion, and, as an essential complement to technological progress, aeronautical biofuels.

In this context, the invention relates more particularly to the aspects related to aircraft turbomachine compressors. The compressors comprise stator blades for straightening a primary flow, or “straightener”. The air flow may have unwanted secondary flows, due in particular to a separation at the extrados and intrados, which has negative consequences on the performance of the compressor impacting the efficiency of the turbomachine.

Published patent document WO 2019/228897 A1 discloses vanes of a rectifier extending from a non-axisymmetric surface commonly referred to as “3D contouring”, the latter comprising troughs and bumps intended to limit the occurrence of secondary flows.

However, this solution of providing the stator shrouds with hollows and/or bumps is not suitable for variable pitch vanes (or “VSV” for “Variable Stator Vane”). Indeed, if the design of hollows and/or bumps on the shroud are optimized for a given direction of the air flow, the variations in the speed and/or direction of the flow resulting from the pivoting of the VSV vanes make the contouring suboptimal. For example, we note the appearance of “horseshoe” vortices for VSV vanes at high incidence.

The contouring proposed by document WO 2019/228897 A1 only concerns fixed rectifier blades and therefore does not effectively limit the appearance of secondary flows at the level of a variable-pitch rectifier.

### SUMMARY OF THE INVENTION

### Technical Problem

The invention aims to solve at least one of the problems posed by the prior art. More specifically, the invention aims to propose a blade that guarantees good stability in order to limit intrinsic efficiency losses and to guarantee good efficiency of the compressor of a turbomachine independently of the incidence of the VSV blades.

### Technical Solution

The invention is the result of technological research aimed at very significantly improving the performance of aircraft and, in this sense, contributes to reducing the environmental impact of aircraft. For this purpose, the present invention relates to a variable-pitch stator vane for an aircraft turbomachine, the vane comprising:
a blade for guiding an air flow, the blade having a leading edge and a trailing edge, and an intrados and an extrados extending from the leading edge to the trailing edge; and
one or two platforms arranged at one end or at both ends of the blade, the platform(s) comprising a guide surface for the air flow, the surface comprising a first disc portion on the intrados side and a second disc portion on the extrados side;
   wherein the or at least one of the first or second disc portions comprises a bump.

Advantageously, the platform allows the blade to be fixed in a casing of the turbomachine, preferably by means of a trunnion ensuring a pivot connection with the casing.

Preferably, the blade comprises a single platform arranged at the blade head. More preferably, the blade comprises two platforms, one at the blade head and the other located at the foot of said blade.

The platform(s) comprises/comprise two disc portions, the latter two preferably being viewed in a radial direction. For this purpose, it should be noted that the discs are asymmetrical because their air guiding surface is not flat (comprises one or two bumps).

According to an advantageous embodiment of the invention, the or at least one of the first disc portions comprises a first bump, and the top of said first bump has a position whose projection on the chord line of the vane in line with the platform is distant from the leading edge by 10% or less of the chord.

According to an advantageous embodiment of the invention, the top of the first bump is attached to the intrados or is arranged at a distance from said intrados of between 0% and 30% of a maximum thickness of the blade.

According to an advantageous embodiment of the invention, the or at least one of the second disc portions comprises a second bump.

Advantageously, the second bump makes it possible to delay or even prevent the air flow from stalling at the extrados of the blade.

Preferably, the top of the second bump comprises a position whose projection on the chord of the blade in line with the platform is distant from the trailing edge of the blade by a distance corresponding to 10% or less of the chord.

According to an advantageous embodiment of the invention, the platform comprises a peripheral edge which intersects the radial projection of the extrados on the guide surface at a rear intersection point, the top of the second bump having a position whose projection on the chord line of the blade at right angles to the platform is at a distance from the projection of the rear intersection point on the chord which is less than or equal to 10% of the chord.

According to an advantageous embodiment of the invention, apart from the bump(s), the surface of the first and second disc portions is substantially flat, and the top of the bump(s) rises above the substantially flat surface by a height which is between 0.5 and 5 mm, preferably between 1 and 3 mm.

According to an advantageous embodiment of the invention, the height of the top of the first bump is between 0.1 and 0.3 times the maximum thickness of the blade or between 1 and 3 times said maximum thickness, and/or the height of the top of the second bump is between 0.1 and 0.3 times the maximum thickness of the blade or between 1 to 3 times said maximum thickness.

Advantageously, this height of the bumps makes it possible to minimize secondary flows, while limiting the impact of said bumps on the aerodynamic profile of the blade. Indeed, if the height of the bumps is too great, then a blockage of the air flow may occur.

According to an advantageous embodiment of the invention, the height of the top of the bump(s) is between 1% and 10% of the chord.

According to an advantageous embodiment of the invention, the bump(s) are at a distance from the peripheral edge.

Advantageously, the first bump and/or the second bump is/are confined on the platform and does not extend over the fixed part of the casing, because in the case where the bump(s) are located on a fixed part (turbomachine casing) outside the platform, the homogeneity of the aerodynamic flow risks being impacted. Indeed, the confinement of the bumps on the platforms of the blades of the invention allows said bumps to act on the secondary flows regardless of the incidence of the blade.

According to an advantageous embodiment of the invention, the first bump has a main orientation which forms an angle of between 30° and 60° with the chord of the blade.

Preferably, the main orientation of the first bump corresponds to a direction or a main axis of the extent of said first bump on the platform. For this purpose, the main orientation defines the direction of the largest dimension of said first bump. The main axis is preferably substantially parallel to the guide surface of the platform and can be seen radially.

According to an advantageous embodiment of the invention, the second bump has a truncated cardioid shape.

The invention also relates to an aircraft turbomachine comprising a compressor, said compressor comprising a surface for guiding a substantially axisymmetric air flow with the exception of an annular row of housings, wherein the turbomachine comprises an annular row of vanes according to the invention and one of its aforementioned advantageous embodiments, the platforms of the vanes being received in housings of the casing such that the air guiding surfaces of the platforms are substantially flush with the air flow guiding surface of the casing.

Advantageously, the blade of the invention makes it possible to avoid the appearance of secondary flows at the level of the variable-timing stator rectifier of a compressor of the turbomachine.

Indeed, the first hump makes it possible to limit or even prevent an undesirable secondary flow from rising towards the extrados of a neighboring blade in a row of stator blades of the compressor. At the same time, the second hump makes it possible to better guide the air flow in contact with the extrados and to prevent it from separating from said extrados.

Furthermore, the invention is particularly advantageous because it makes it possible to improve the performance of aircraft compressors and the overall efficiency of turbomachines, which translates into a reduction in fuel consumption and greenhouse gas emissions, thereby reducing the environmental impact of aircraft.

It is understood that each detail of an embodiment below can be combined with each other detail of the other embodiments.

### BRIEF DESCRIPTION OF THE DRAWINGS

FIG. 1 illustrates a sectional view of a compressor of an axial turbomachine;

FIG. 2 shows a perspective view of a blade according to the invention;

FIG. 3 illustrates a radial view of the blade according to a first embodiment of the invention;

FIG. 4 illustrates a side view of the blade of FIG. 3;

FIG. 5 illustrates a radial view of a blade according to a second embodiment of the invention;

FIG. 6 illustrates a side view of the blade of FIG. 5;

FIG. 7 illustrates a radial view of a blade according to a third embodiment of the invention.

### DETAILED DESCRIPTION OF THE EMBODIMENTS

In the following description, the terms “internal”, “inner”, “lower”, “outer” and “upper” refer to a positioning relative to the axis of rotation of an axial turbomachine. The axial direction corresponds to the direction along the axis of rotation of the turbomachine, the lengths being measured axially. The widths are measured along the circumference. The radial direction is perpendicular to the axis of rotation. The upstream and downstream refer to the main flow direction of the airflow in the turbomachine.

The dimensions of the figures are not to scale and in particular the thicknesses or radial dimensions are exaggerated to facilitate reading of the figures.

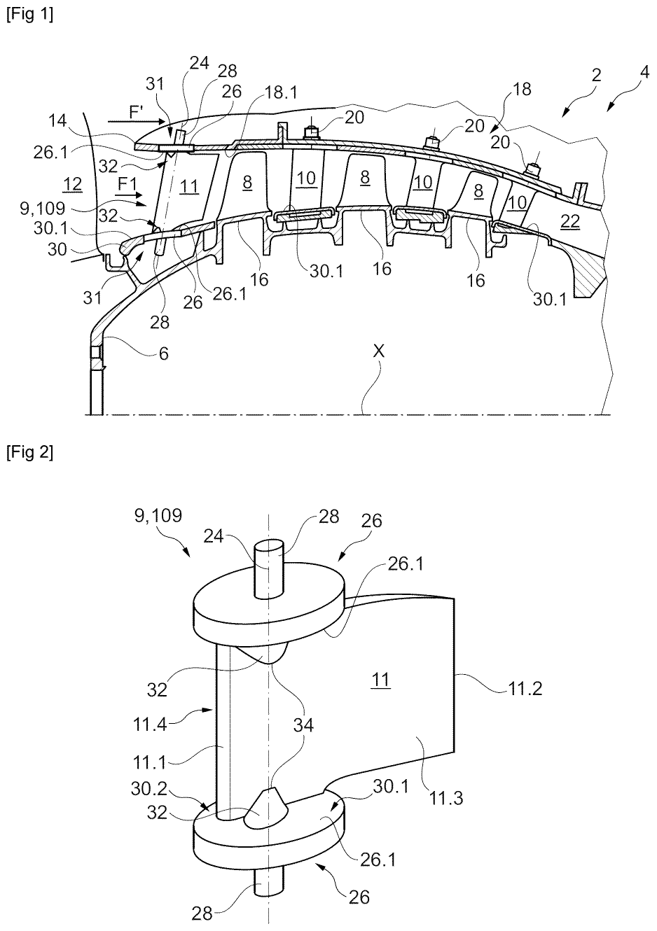

FIG. 1 shows a sectional view of a compressor 2 of an axial turbomachine 4.

The turbomachine 4 may correspond to a turbojet, turbofan, turboprop, turbomotor or any other dual-flow turbine. Alternatively, the turbomachine 4 may correspond to a multi-flow turbomachine, such as a non-ducted triple-flow turbojet (CROR “Counter-Rotating Open Rotor” or USF “Unducted Single Fan”), or any other triple-flow turbomachine.

Preferably, the compressor 2 corresponds to a low-pressure compressor 2 or to a high-pressure compressor (not shown). The turbomachine 4 further comprises other components not shown in FIG. 1, such as a high-pressure compressor, a combustion chamber and one or more turbine levels. In operation, the mechanical power of the turbine transmitted via the central shaft to the rotor 6 sets the two compressors in motion. The latter comprise several rows of rotor blades 8 associated with rows of stator blades 10. The rotation of the rotor 6 about its axis of rotation X thus makes it possible to generate an air flow and to gradually compress the latter up to the inlet of the combustion chamber.

A fan 12 (partially illustrated) is coupled to the rotor 6 and generates an air flow which is divided into a radially internal flow F1, commonly called primary flow F1, and into a radially external flow F′, which may correspond to a secondary flow F′ in the context of a dual-flow turbomachine, or to a tertiary flow F′ of a triple-flow turbomachine 4.

The radially external flow F′ passes through an annular duct (partially shown). The secondary flow is accelerated to generate a thrust reaction useful for the flight of an aircraft. The primary flow F1 and the radially external flow F′ are both annular and separated by a separation nozzle 14.

It can be seen in FIG. 1 that the rotor 12 comprises several rows of rotor blades 8, in this case three, and several rows of stator blades 10, in this case three; the latter make it possible to convert the speed of the air flow F1 into pressure, in particular into static pressure.

The rotor blades 8 may extend radially from a rotor support 16 which may be a dovetail platform, an inner crown of a single-piece bladed drum, or any other type of support of a composite rotor.

The stator blades 10 extend essentially radially from an outer casing 18. They can be fixed and immobilized there using fixing pins 20. They radially cross the primary flow F1. The stator blades 10 can have a fixed chord (radially constant) relative to the outer casing 18.

The low-pressure compressor 2 comprises at the inlet of a primary flow vein 22 F1, a row of variable-pitch stator rectifier blades 9.

Preferably, the variable setting of the blades 9 is ensured by means of an actuation system (not illustrated) regulating the angle formed by the blades 11 of the blades 9 around an axis 24.

In this configuration, each blade 9 comprises a blade 11 as well as one or preferably two platforms 26 which are substantially circular and arranged at the two ends of the blade 11. Each platform 26 is provided with a journal 28, on the side opposite the blade 11 and providing a pivot connection with the outer casing 18 or inner casing 30. The outer casing 18 is delimited radially internally by an upper surface 18.1 for guiding the primary flow F1, and the inner casing 30 is delimited radially externally by an inner guide surface 30.1.

Advantageously, the blades 11 of the rectifier are identical and annularly aligned. The housing 18, 30 comprises housings 31 distributed annularly around the axis X and in which the platforms 26 are housed and pivotally mounted.

Advantageously, the platforms 26 comprise axisymmetric air guide surfaces 26.1 (circular, cylindrical, conical, etc.) which are substantially flat and flush with the air flow guide surfaces 18.1 and 30.1 of the casing 18, 30. Suitable seals can ensure sealing between the platforms 26 and the casing.

FIG. 2 shows a perspective view of a blade 9 according to the invention. The blade 11 of the blade 9 comprises a leading edge 11.1 and a trailing edge 11.2, as well as a lower surface 11.3 and an upper surface 11.4 extending from the leading edge 11.1 to the trailing edge 11.2.

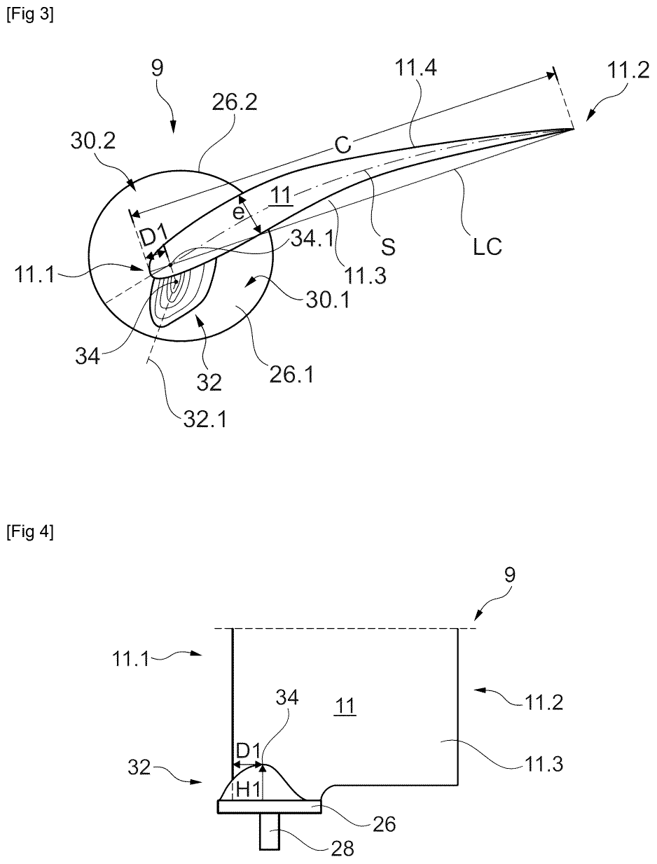

The blade 11 further comprises a chord line LC, a skeleton line S and a maximum thickness e (illustrated in FIG. 3).

The guide surface 26.1 of the platform 26 comprises a first disc portion 30.1 on the intrados side 11.3 and a second disc portion 30.2 on the extrados side 11.4. The separation between the first 30.1 and the second disc portion 30.2 preferably corresponds to the extension of the skeleton line S or the camber line S of the blade 11 on the guide surface 26.1 (seen radially).

According to a first embodiment of the invention, the first portion 30.1 comprises a first bump 32. Details on the shape and position of the first bump 32 will be detailed later in this description.

FIG. 3 illustrates a radial view of the blade 9 according to the first embodiment of the invention.

Contour lines (iso-contour) can be seen illustrating the first bump 32 comprising a peak 34 having a projection 34.1 on the chord line LC of the blade 11 which is preferentially distant from the leading edge 11.1 by a distance D1 corresponding to at most 10% of the chord C. Alternatively, the distance D1 can be greater without however exceeding 15% of the chord C.

Preferably, the apex 34 of the first bump 32 is arranged adjacent (substantially attached) to the intrados 11.3. However, the apex 34 may be in the vicinity of the intrados 11.3, ie, arranged at a distance of between 0% and 50% of the maximum thickness e, and preferably of between 0% and 30%.

More preferably, the summit 34 is at most 3 mm from the intrados 11.3.

Advantageously, such an arrangement of the first bump 32 makes it possible to have a direct impact on the “horseshoe” vortex, because it makes it possible to avoid the boundary layer detaching at the level of the blade wall on the intrados 11.3 and/or extrados 11.4 side.

The first hump 32 comprises a substantially circular or oval or elliptical shape, said hump 32 being preferably substantially elliptical. However, the shape of the hump 32 may be truncated by the intrados 11.3. The first hump 32 comprises a main orientation illustrated by a main axis 32.1 which may form an angle of between 30° and 60° with the chord line LC, and preferably an angle of approximately 45° (±10%) with the chord line LC.

Indeed, an orientation of the first bump 32 at 0° relative to the chord line LC does not obstruct secondary flows, and an orientation at 90° with the chord line LC does obstruct unwanted flows, but generates higher aerodynamic losses.

Advantageously, the orientation of the first bump 32 as well as the position of the apex 34 makes it possible to obstruct the horseshoe vortex in order to prevent it from passing towards the extrados 11.4, and this, in all possible orientations of the blade 9 around its axis 24. To this end, the blade 9 makes it possible to ensure optimal operation of the aircraft compressor in all flight conditions.

FIG. 4 illustrates a side view of the blade 9 of FIG. 3. Here the blade 9 is partially illustrated, in particular a lower half of said blade 9 is shown, and the dotted line may possibly correspond to an axis of symmetry of the blade 9.

It can be seen that the top 34 of the first bump 32 rises above the substantially flat surface 26.1 by a height H1.

Preferably, the height H1 of the summit 34 is between 1% and 10% of the chord of the blade 11.

The height H1 is determined as a function of the maximum thickness e (illustrated in FIG. 3) of the blade 11 at the platform 26 (i.e. in cases where the thickness of the blade 9 is not constant over its radial height, the height of the bump is defined relative to the maximum thickness). Indeed, it is preferable for the height H1 to be between 0.1 and 3 times the maximum thickness e. More preferably, the height H1 is between 0.1 and 0.3 times the maximum thickness e when the first bump 32 is at the blade tip, and between 1 and 3 times the thickness e when said bump 32 is at the blade root.

For this purpose, the height H1 may, for example, correspond to 1 mm when the thickness e is equal to 10 mm, in particular in the case where the first bump 32 is located on the platform at the blade head, or said height H1 may be equal to 3 mm if the thickness e is 1 mm, in particular in the case where the first bump 32 is located on the platform at the blade root.

Preferably, the height H1 is between 0.5 and 5 mm, and more preferably between 1 and 3 mm. Below this interval (height H1 less than 1 mm), the tolerances of the shape of the first bump 32 can affect the effectiveness of the latter in slowing down secondary flows. At the same time, beyond this interval (height H1 greater than 3 mm), the performance of the compressor at nominal incidence risks being degraded.

The first hump 32 may have a generally convex and/or concave shape. Preferably, the first hump 32 has a convex shape at an upstream portion corresponding to approximately half of the extent of said hump 32 (here the term approximately corresponds to ±20% of the extent), said first hump 32 has a concave shape on a downstream portion corresponding to another half, and more preferably, the convex half is arranged downstream of the hump 32 (closer to the trailing edge 11.2) so as to arrange the convex portion in direct contact with the secondary flows to block them and allow the flow to be better guided downstream with the concave half.

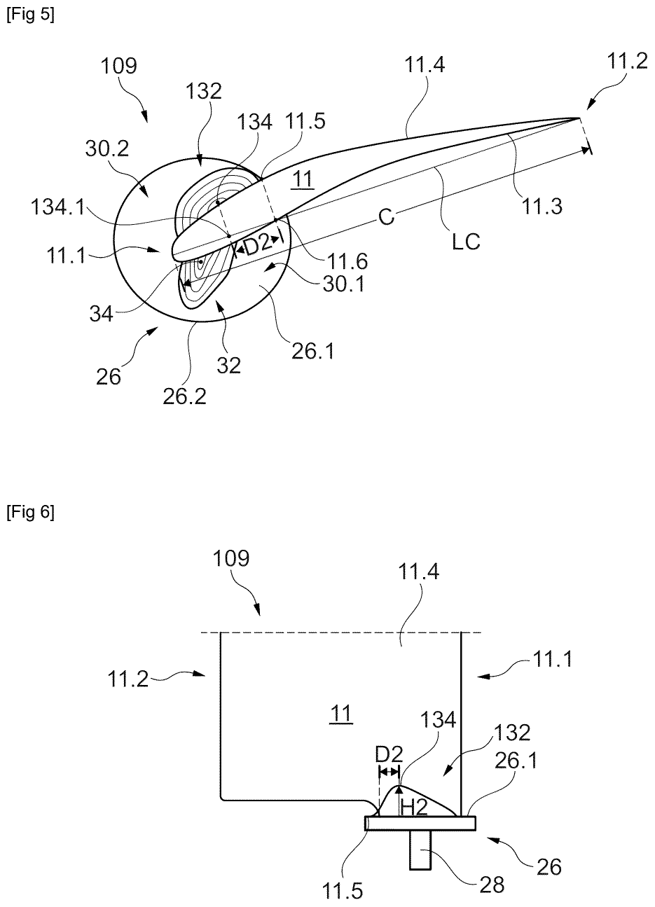

FIG. 5 illustrates a radial view of a blade 109 according to a second embodiment of the invention, in which the blade 109 comprises a second bump 132 in line with the second disc portion 30.2 of the surface 26.1.

Identical elements between the first and second embodiments have the same reference signs, while additional or substantially similar elements are incremented by 100.

Preferably, the blade 109 comprises the first bump 32 in line with the first disc portion 30.1 and the second bump 132 arranged in line with the second disc portion 30.2.

The platform 26 includes a peripheral edge 26.2, and the first 32 and the second bump 132 are spaced from said peripheral edge 26.2. This allows the 3D contouring to rotate entirely with the blade 109.

The extrados 11.4 has a rear intersection point 11.5 with the platform 26, and precisely with the peripheral edge 26.2, said point 11.5 corresponds to an intersection between said peripheral edge 26.2 and the radial projection of the extrados 11.4 on the guide surface 26.1. For this purpose, the rear intersection point 11.5 is located downstream of the platform 26 (close to the trailing edge 11.2 of the blade 11), and the second bump 132 comprises a peak 134 whose projection 134.1 on the chord line LC is distant by a distance D2 from a projection 11.6 of the rear intersection point 11.5 on the chord line LC.

Preferably, the distance D2 corresponds to at most 15% of the chord C, and more preferably, the distance D2 corresponds to 10% or less of the chord C.

In an alternative not shown, the vertex 134 can be positioned so that its projection 134.1 on the chord line LC is distant from the leading edge 11.1 by a distance D1 corresponding to at least 10% of the chord C.

The apex 134 is attached to the extrados 11.4 or arranged at a distance from said extrados 11.4 of between 0% and 50%, and preferably between 0% and 30% of the maximum thickness e, similarly to the arrangement of the apex 34 of the first bump 32 relative to the intrados 11.3.

Advantageously, such an arrangement of the second bump 132 makes it possible to delay or even avoid the separation of the boundary layer at the level of the wall of the blade on the extrados side 11.4.

In this configuration, the first bump 32 acts directly on the “horseshoe” vortex phenomenon so as to limit its impact, and the second bump 132 makes it possible to curatively compensate for any stalls that may be caused at the right of the extrados 11.4 by the phenomenon.

Preferably, the second hump 132 comprises a truncated cardioid shape, or a substantially circular, or oval, or elliptical shape, said second hump 132 preferably being in the shape of a truncated cardioid with a main orientation substantially parallel to the extrados 11.4, so that the second hump 132 extends in its main direction which follows the curvature of the extrados 11.4. Indeed, the second hump 132 follows the contour of the extrados 11.4 so as to be able to better guide the air flow and to prevent it from detaching from said extrados 11.4.

FIG. 6 illustrates a side view of the blade 109 of FIG. 5. It can be seen that the apex 134 of the second bump 132 rises above the substantially flat surface 26.1 by a height H2.

Preferably, the height H2 of the top 134 is determined as a function of the maximum thickness e similarly to the height H1 of the first bump 32. For this purpose, the height H2 is between 0.1 and 3 times the thickness e, and more preferably between 0.1 and 0.3 times the maximum thickness e when the second bump 132 is at the blade tip, and between 1 and 3 times the thickness e when said bump 132 is at the blade root.

The height H2 may, for example, correspond to 1 mm when the thickness e is equal to 10 mm, in particular in the case where the second bump 132 is located on the platform at the blade head, or said height H2 may be equal to 3 mm if the thickness e is 1 mm, in particular in the case where the second bump 132 is located on the platform at the blade root.

However, it should be noted that on the same substantially flat surface 26.1, the height H2 is preferentially less than the height H1.

Preferably, the height H2 is between 1% and 10% of the chord of the blade 11. More preferably, the height H2 is between 0.5 and 5 mm, and more preferably between 1 and 3 mm.

The second hump 132 may have a generally convex and/or concave shape. Preferably, the second hump 132 has a convex shape at an upstream portion corresponding to approximately half of the extent of said second hump 132 (here the term approximately corresponds to ±20% of the extent), said second hump 132 has a concave shape on a downstream portion corresponding to another half, and more preferably, the convex half is arranged downstream of the hump 132 (closer to the trailing edge 11.2) so as to allow better guidance of the air flow downstream.

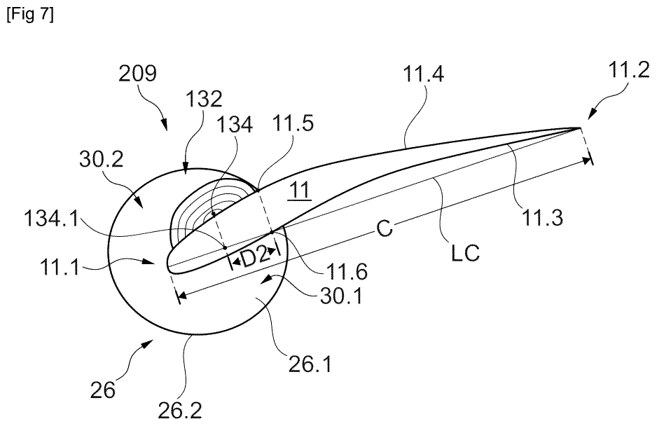

FIG. 7 illustrates a radial view of a blade 209 according to a third embodiment of the invention, in which the substantially flat surface 26.1 of the blade 209 comprises only the second bump 132 in line with the second disc portion 30.2. Indeed, the blade 209 according to the third embodiment, is devoid of the first bump 32 (illustrated in FIGS. 1-6). In this configuration, during high incidences, the second bump 132 makes it possible to maintain a flow of the air flow on the extrados 11.4 in order to avoid its detachment which could be caused by the horseshoe vortex.

It is understood that the three embodiments of FIGS. 3, 5 and 7 can be combined on the same blade: a blade can have a bump on the intrados side at the foot and a bump on the extrados side at the head (or vice versa), or have two bumps on one of its platforms and none on another.

Also, different blades of the same row of blades can have one and/or the other of the configurations of the three illustrated embodiments.

1. A variable-pitch vane for an aircraft turbomachine stator, the vane comprising:
a blade for guiding an air flow, the blade including a leading edge and a trailing edge, as well as an intrados and an extrados extending from the leading edge to the trailing edge; and
one or two platforms arranged at one end or at both ends of the blade, the platform(s) comprising a guide surface for the air flow, the guide surface comprising a first disc portion on the intrados side and a second disc portion on the extrados side;
wherein at least one of the first disc portion and the second disc portion comprises a bump.

2. The vane according to claim 1, wherein the bump includes a first bump, and wherein the first disc portion comprises the first bump, and an apex of said first bump has a position whose projection on a chord line of the vane in line with the platform is distant from the leading edge by 10% or less of the chord line.

3. The vane according to claim 2, wherein a top of the first bump is attached to the intrados.

4. The vane according to claim 3, wherein the bump includes a second bump, and wherein the second disc portion comprises the second bump.

5. The vane according to claim 4, wherein the platform comprises a peripheral edge which intersects a radial projection of the extrados on the guide surface at a rear intersection point, an apex of the second bump including a position whose projection on a chord line of the vane at right angles to the platform is at a distance from the projection of the rear intersection point on the chord line which is less than or equal to 10% of the chord line.

6. The vane according to claim 4, wherein, apart from the first bump and the second bump, the guide surface of the first disc portion and the second disc portion is substantially flat, and in that the top of the first bump and the second bump rises above the guide surface, which is a substantially flat surface, by a height which is between 0.5 and 5 mm.

7. The vane according to the claim 6, wherein the height of the top of the first bump is between 0.1 and 0.3 times a maximum thickness of the blade or between 1 to 3 times said maximum thickness, and/or the height of the top of the second bump is between 0.1 and 0.3 times the maximum thickness of the blade or between 1 to 3 times said maximum thickness.

8. The vane according to claim 6, wherein the height of the top of the first bump and the second bump is between 1% and 10% of the chord line.

9. The vane according to claim 5, wherein the first bump and the second bump are at a distance from the peripheral edge.

10. The vane according to one of claim 1, wherein the first bump has a main orientation which forms an angle of between 30° and 60° with a chord line of the blade.

11. The vane according to claim 4, wherein the second bump defines a truncated cardioid shape.

12. A turbomachine, comprising:
a compressor, said compressor comprising a guide surface for a substantially axisymmetric air flow,
the vanes according to claim 1, the platforms of the vanes being received in housings of a casing such that the air guide surfaces of the platforms are substantially flush with the guide surface for the air flow of the casing.

13. The vane according to claim 2, wherein a top of the first bump is arranged at a distance from said intrados of between 0% and 30% of a maximum thickness of the blade.

14. The vane according to claim 4, wherein, apart from the first bump and the second bump, the guide surface of the first disc portion and the second disc portion is substantially flat, and in that the top of the first bump and the second bump rises above the guide surface, which is a substantially flat surface, by a height which is between 1 and 3 mm.
